(19) United States
(12) Patent Application Publication
(10) Pub. No.: US 2010/0299855 A1
(43) Pub. Date: Dec. 2, 2010

(54) Control apparatus

(76) Inventor: William D. Megeath, Fresno, CA (US)

Correspondence Address: Rodney K. Worrel;WORREL & WORREL, St. Croix Professioal Center, Suite 121, 2109 W. Bullard Avenue, Fresno, CA, 93711-1258, US

(21) Appl. No.: 12/455,283

(22) Filed: May 30, 2009

(51) Int. Cl. A46B 13/00; B25G 1/00; B25G 1/10

(52) U.S. Cl. 15/22.1; 16/110.1; 16/430

(57) ABSTRACT

A control apparatus for a work object having a member with a substantially convoluted configuration such that it can be disposed in an operational position in contact with the work object in at least two points of contact to retain the control apparatus substantially in an operational position relative to the work object.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a control apparatus and, more particularly, to a control apparatus which permits a work object, such as an implement, to be used with an ease and precision not heretofore achieved in the art.

(2) Description of the Prior Art

Over historically considerable periods of time, work objects, such as for example, hand implements, have remained substantially unchanged. This fact exists, not-withstanding substantial improvements in other areas of art, the advancement in materials available for such usage, the multiplicity of new environments requiring their use and a plurality of other considerations.

While perhaps mundane in their need and usage, that very fact, makes such implements frustratingly inefficient and ineffective. Such implements have been used for such an extended period of time that their inadequacies have, in many uses, simply been accepted as a natural impediment for accomplishing the tasks for which they were designed.

Nonetheless, the usage of such implements as, for example a broom, illustrates the difficulties that are accepted as routine. The broom may be too long or too short for convenient and comfortable use. The broom handle is frequently difficult to grasp in use and, once some period of such use has elapsed, may cause bruising or blistering of the skin. They may be difficult to maneuver as into corners or other confined areas. For a person compromised in some manner such as confined to a wheel chair or otherwise limited in some manner, the broom may be very difficult or impossible to use.

These same impediments as well as others are present in one form or another with other types of implements are, for example, other work objects such as weapons, tools, implements intended to reach confined and/or distant surfaces. More specifically, the remote end of a work object may be very difficult, or impossible, because of an inability properly to grasp the work object.

Therefore, it has long been known that it would be desirable to have a means by which an implement, or other work object, can be used more conveniently and comfortably to achieve its objectives; which possess a precision in use not heretofore achieved in the art; which can be used conveniently by disabled people or people otherwise physically compromised in some manner; which does not require use by a person of a particular stature; and which is otherwise fully effective in achieving its operational objectives.

### BRIEF SUMMARY OF THE INVENTION

Therefore, it is an object of the present invention to provide an improved control apparatus.

Another object is to provide such a control apparatus which is of improved design over prior art devices and particularly those which have been known to society for historically significant periods of time.

Another object is to provide such a control apparatus which has application to a wide variety of types of work objects.

Another object is to provide such a control apparatus which is essentially universally available for use by people to different statures, physical capabilities and whether or not disabled in some manner.

Another object is to provide such a control apparatus which provides the maximum operational capability for a given work object on which it is employed.

Another object is to provide such a control apparatus which permits the subject work object to be grasped by people having, for example, different sizes and lengths of arms without in anyway affecting the utility thereof.

Another object is to provide such a control apparatus which is strong for dependable yet comfortable use.

Another object is to provide such a control apparatus which can be constructed as an integral part of the work object so as to facilitate the strength and use thereof.

Another object is to provide such a control apparatus which is of minimal cost and maximum utility.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a control apparatus for a work object comprising a member having substantially convoluted configuration adapted to be disposed in an operational position in contract with said work object in at least two points of contact to retain said control apparatus substantially in a plurality of operational positions relative to said work object regardless of the maneuvering of the work object.

### BRIEF DESCRIPTION OF THE SEVERAL VIEWS OF THE DRAWINGS

FIG. 1 is a fragmentary, front elevation of a human being grasping a work object using the control apparatus of the present invention.

FIG. 2 is a somewhat enlarged perspective view of a work object, in this case a broom, showing the control apparatus from that perspective.

FIG. 3 is a perspective view of the control apparatus mounted as an integral part of the broom handle and shown from the opposite perspective.

FIG. 4 is a side elevation of the broom mounting the control apparatus of the present invention.

FIG. 5 is a front elevation of the broom mounting the control apparatus of the present invention.

FIG. 6 is a side elevation of the broom mounting the control apparatus and taken from the side thereof opposite to that shown in FIG. 4.

FIG. 7 is a rear elevation of the broom mounting the control apparatus of the present invention and viewed from the portion opposite to that shown in FIG. 5.

FIG. 8 is a somewhat enlarged top plan view of the broom mounting the control apparatus.

FIG. 9 is a bottom plan view of the broom of FIG. 8 taken from a position opposite to that shown in FIG. 8.

### DETAILED DESCRIPTION OF THE INVENTION

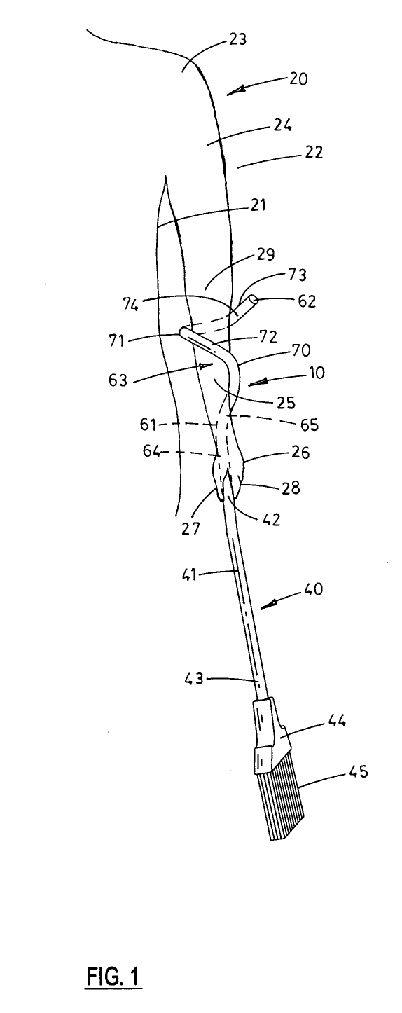

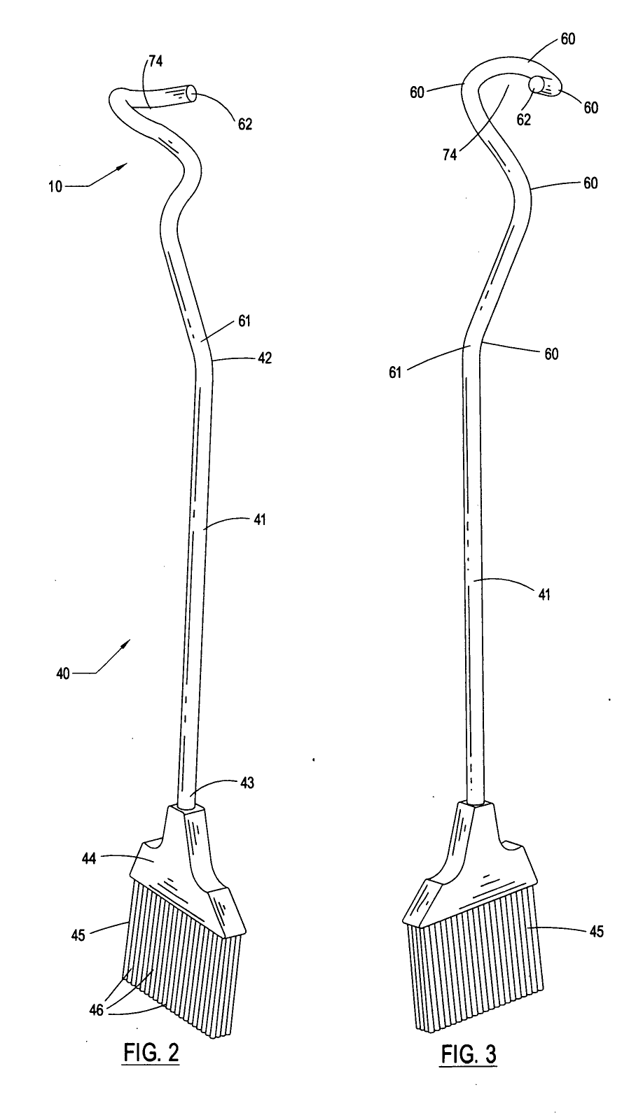

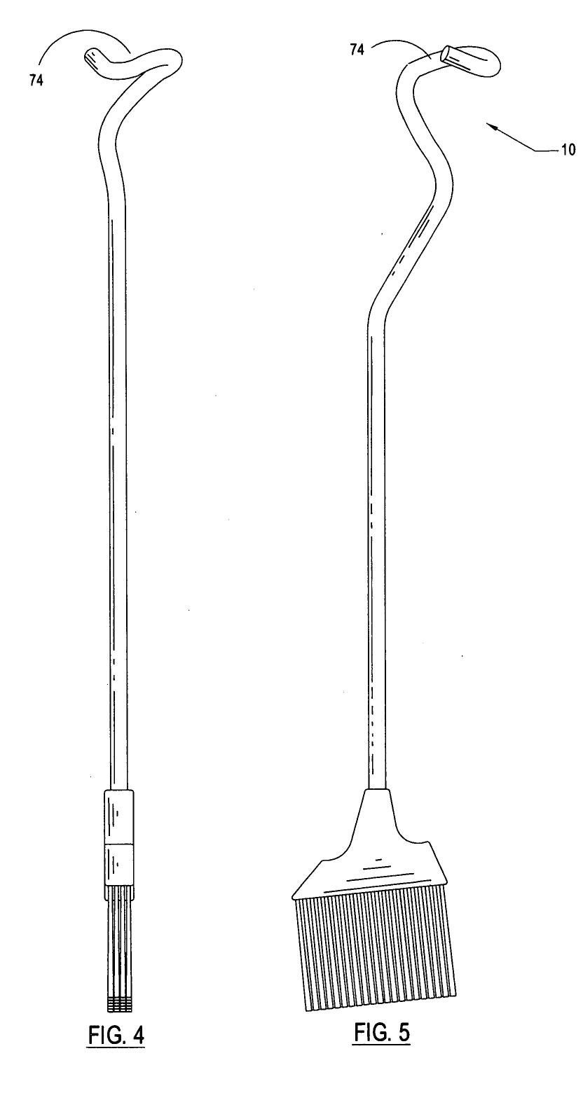

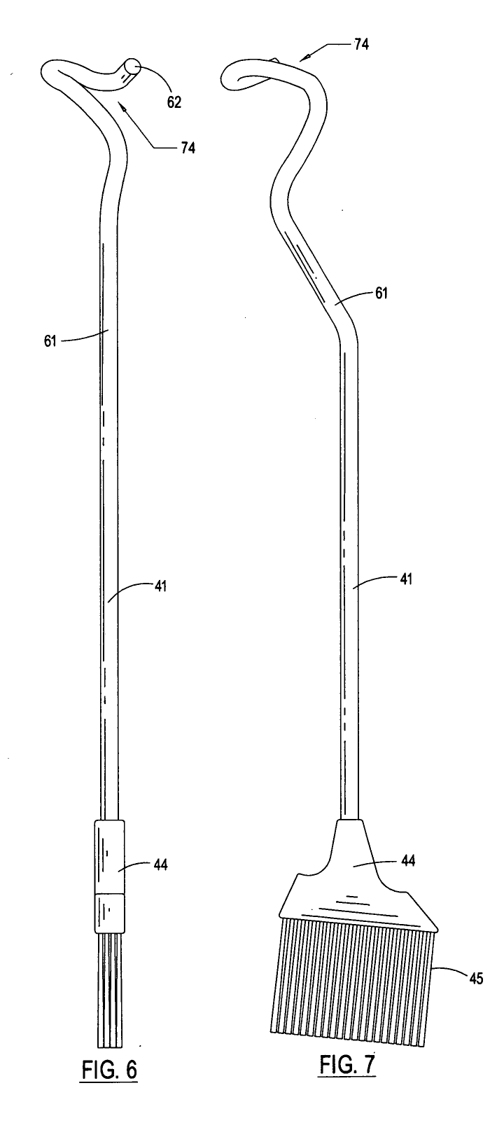

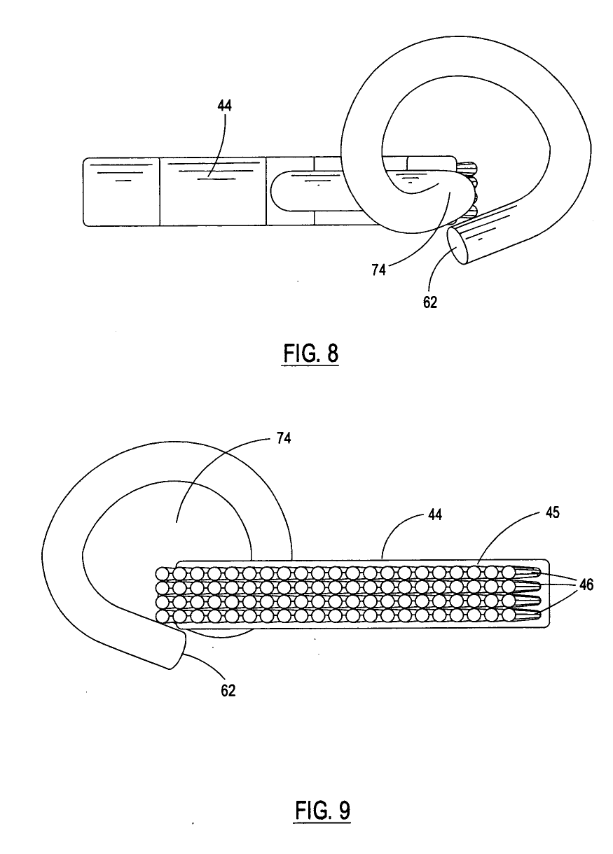

Referring more particularly to the drawings, the control apparatus of the present invention in generally indicated by the numeral 10 in FIG. 1.

For illustrative convenience, in FIG. 1, a human being, or person, is generally indicated by the numeral 20. The person is shown fragmentarily therein. The person has a torso 21 and an arm 22. The arm extends downwardly from a shoulder 23, as shown in FIG. 1. The arm has an upper arm 24 and a forearm 25. The forearm extends to a hand 26 having a thumb 27 and fingers 28. The upper arm and forearm are interconnected by an elbow generally indicated by the numeral 29.

To illustrate operation of the control apparatus 10 of the present invention, an implement is generally indicated by the numeral 40. The implement, in the illustrative example, is a broom which has been modified in accordance with the present invention. The broom has an elongated handle 41 with an upper end portion 42 and an opposite lower end portion 43. An intermediate or brush mounting housing 44 is mounted on the lower end portion 43. The mounting housing has a brush portion 45 mounted on the lower end portion of the handle. The brush portion is comprised of a plurality of semi-flexible bristles 46 mounted on and extending from the brush mounting housing.

The control apparatus 10 of the present invention is mounted on, or more precisely, integral with and extended from the upper end portion 42 of the handle 41. The control apparatus is rigid with the handle 41 and has a number of curved bends 60 constituting parts of the control apparatus 10 of the subject invention. While the curved bends may look randomly shaped as positioned in one or more of the views of the drawings this is not the case. The control apparatus has proximal end 61 mounted on the upper end portion 42 of the handle 41 and an opposite distal end 62.

As can best be seen in FIG. 1, the control apparatus 10 is depicted therein in an operational relationship to the arm 22 and the identified portions thereof. There is a plurality of operational relationships which the control apparatus conforms relative to the arm and help to define the structure of the control apparatus. Between the proximal end 61 and the distal end 62, the curved bends 60, in total, define a configuration resembling a helix. For purposes of descriptive convenience, the portion of the control apparatus between the proximal end and the distal end is referred to herein as a control bar 63. The control bar is rigid so as not to change its form under the application of force thereto. The specific configuration extends from its proximal end from a substantially straight grasping portion 64, adapted to be grasped by the hand 26, as shown in FIG. 1. In the direction of the distal portion, the control bar extends behind the forearm 25 as a brace portion 65 which, frequently in use, rests or presses against the backside of that portion of the forearm. From the backside of the forearm, the control bar extends in a first convoluted portion 70 which is one of the curved bends 60 and which extends about the forearm and crosses the front side of the forearm at the angle shown in FIG. 1. The control bar, frequently in use rests or presses against the front side of the forearm.

The control bar extends from the first convoluted portion 70 into a second convoluted portion 71. The second convoluted portion, a curved bend, extends about the inner side of the forearm 25 and in a first substantially straight position 72 just below or adjacent to the elbow 29. Frequently in use, the first substantially straight portion 72 rests or presses just below the elbow as will hereinafter be described.

From the first substantially straight portion 72, the control bar forms a second substantially straight portion 73 which diverges from the first substantially straight portion 72 and extends to the distal end 62. The second substantially straight portion thereby defines a passage 74 between the distal end 62 and the second substantially straight portion dimensional comfortably to receive the forearm 25, as best shown in FIG. 1.

### Operation

The operation of the described embodiment of the subject invention is believed to be clearly apparent and is briefly summarized at this point.

Use of the control apparatus 10 may appear to be intuitive in that it would appear that the forearm 25 of the person 20 is simply inserted into the area defined by the control bar 63, the proximal end portion is grasped, as shown in FIG. 1, and the implement 40 maneuvered for use. It is the case that the control bar 63, is mounted or installed on the arm in this manner.

However, the control bar 63 can be employed in a manner which may not initially be fully apparent to begin with. It may become more fully understood after brief instruction and/or practice with the control apparatus 10. In essence, the control apparatus automatically adjusts to the natural movement of the arm 22 and, more particularly, the forearm 25. The engagement of portions of the forearm can apply pressure to the control bar 63 at specific points simply by engaging the control bar and applying pressure in the direction desired to move the implement in the direction desired. This control applied to the implement permits more precise movement, the application of more force, requires holding and control of the implement with only one arm and otherwise is fully effective in accomplishing its operational objectives. Furthermore, people of compromised physical health and mobility can use the control apparatus to move the implement with ease. This is true of people confined to wheelchairs as well as others.

Therefore, the control apparatus of the present invention is particularly well suited to use with a work object for the controlled positioning thereof; provides a comfortable and yet precise operation for use by virtually any human being regardless of the person's physical condition; engages an appendage of the human body for precise positioning of the work object; is useful to provide its benefits on, or in conjunction with, virtually any type of implement, including hand implements; and is otherwise entirely successful in achieving its operational objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. A control apparatus for a work object comprising a member having a substantially convoluted configuration such that it can be disposed in an operational position relative to said work object in at least two points of contact therewith to retain said control apparatus substantially in said operational position.

2. The control apparatus of claim 1 wherein said member is substantially rigid and said at least two points of contact are spaced from each other sufficiently substantially to grasp said work object so as to retain it in said operational position.

3. The control apparatus of claim 2 wherein an implement is mounted on said member and is substantially rigid relative thereto so that said member retains said work object in substantially fixed position relative to said implement substantially through a plurality of work positions under the control of said work object.

4. The control apparatus of claim 3 wherein said work object is an appendage of a human body, the implement has a work end and said member is mounted on the implement substantially on the opposite end thereof whereby said appendage can be employed to move the work end through a range of said operational positions.

5. The control apparatus of claim 4 wherein said implement has a handle portion upon which said member is mounted and said appendage is an arm of a human being having an elbow and a hand, the handle portion of the implement is disposed to be grasped by said hand with said member convoluted so as to wind about said arm substantially between the hand and the elbow in contact with the arm at two or more points of contact so as to permit the arm to apply leverage to the work end of the implement by selective movement of said arm.

6. The control apparatus of claim 5 wherein said member has a configuration substantially of a helix whereby the member is positionable to extend about the arm and substantially behind said arm to permit substantially precise movement of said work end through said range of operational positions.

7. The control apparatus of claim 6 wherein said member has a passage about which said member is wound substantially in the form of a helix and dimensioned to receive and substantially conform to said arm when the arm is in said passage.

8. The control apparatus of claim 7 wherein said helix configuration of the member is foreshortened to provide a space for the arm to be passed into said passage within said helix configuration of the member.

9. The control apparatus of claim 8 wherein said work end is a broom disposed in spaced relation to the member and the handle is of a length such that a human being can use the broom while substantially fully erect.

10. The control apparatus of claim 9 wherein the handle has an upper portion dimensioned to be grasped by the hand of the human being and said substantially helix configuration of the member is dimensioned substantially to wrap around the arm of the user between said hand and said elbow.

11. The control apparatus of claim 10 wherein said point of the upper portion of the handle grasped by the hand is dimensioned to be grasped by the human being in such a manner as to permit the movement of the implement and said helix configuration of the member grasps the arm of the human being thereabove whereby said point of the upper portion of the handle thereby becomes substantially a fulcrum for the handle and said substantially helix configuration of the member becomes substantially a lever during use of the implement.
